(19) United States
(12) Patent Application Publication
(10) Pub. No.: US 2007/0248793 A1
(43) Pub. Date: Oct. 25, 2007

(54) Open elongate profile

(76) Inventors: Armin Herb, Apfeldorf (DE); Armin Hoffmann, Landsberg (DE); Fritz Hermann, Landsberg (DE); Christoph Wiedner, Sulz (AT)

Correspondence Address: ABELMAN, FRAYNE & SCHWAB, 666 THIRD AVENUE, 10TH FLOOR, NEW YORK, NY, 10017, US

(21) Appl. No.: 11/788,593

(22) Filed: Apr. 19, 2007

(30) Foreign Application Priority Data
Apr. 20, 2006 (DE) 10 2006 000 188.5

(51) Int. Cl. B32B 3/04; B32B 3/00

(52) U.S. Cl. 428/122; 428/156

(57) ABSTRACT

An open elongate profile has side walls (12, 13; 22; 32) oriented relative to each other in a direction of a longitudinal extension (L) of the side walls, with at least one of the side walls (12; 22; 32) having at least one thickness-reduced region (14; 24; 34) along its longitudinal extent (L) and a shaped profile (15; 25; 35) provided in the at least one thickness-reduced region (14; 24; 34) of the at least one of the side walls (12; 22; 32).

### BACKGROUND OF THE INVENTION

1. Field of the Invention

The present invention relates to an open elongate profile having side walls oriented relative to each other in a direction of a longitudinal extent of the side walls, with at least one of the side walls having at least one thickness-reduced region along their longitudinal extension.

The present invention also relates to a method of manufacturing of such an open elongate profile.

2. Description of the Prior Art

Open elongate profiles, which have side walls arranged at an angle to each other and which are produced from a strip-shaped rolling stock, are known in different forms. E.g., some of the open elongate profiles have two side walls which form an open L-shaped profile. For forming U-shaped or C-shaped open profile, the profile has three side walls of which two side walls extend parallel to each other and are arranged on the third wall. With material-intensive open elongate profiles, the portion of the costs of the material constitutes more than 70% of overall production costs. Thus, reduction in the amount of the used material leads to a significant reduction of the production costs.

From static point of view, an open elongate profile need not necessarily have a constant thickness, material thickness, over its entire circumference. Therefore, the thickness can be reduced in sections of an open elongate profile which are subjected to smaller loads and, thus, the costs of material can also be reduced. If the thickness-reduced regions are formed in an elongate profile, which is produced from a strip-shaped rolling stock, later in accordance with a finally desired shape of the profile, load-carrying capability, e.g., and section modulus of the open elongate profile are affected only insignificantly.

German Publication DE 101 13 610 A1 discloses different elongate profiles the side walls of which oriented relative to each other in a direction of their longitudinal extent, have each at least one thickness reduced region along their longitudinal extent.

The drawback of the elongate profiles of this German Publication consists in that when the profile is subjected to high point or concentrated loads or as a result of other factors, e.g., during transportation or mounting of the profile, undesired deformation in the sections of the thickness-reduced regions of the open profile can take place.

Accordingly, an object of the present invention is to provide an open elongate profile which, despite the presence of thickness-reduced regions, is versatile in its use.

Another object of the present invention is to provide a method of forming an open elongate profile with thickness-reduced regions and which can be easily integrated in a conventional process for producing open elongate profiles.

### SUMMARY OF THE INVENTION

These and other objects of the present invention, which will become apparent hereinafter, are achieved, according to the invention by providing the thickness-reduced region or regions of side walls with a shaped profile, and by forming the shaped profile with two oppositely arranged profiled rolls in a direction transverse to the longitudinal extension of the side wall or walls.

With the shaped profile being provided only in the thickness-reduced region, this region is reinforced without use of additional material, and the stiffness of the side wall, which is provided with at least one thickness-reduced region extending in a direction of the longitudinal extent of the side wall, approximates to the stiffness of the side wall having a constant thickness over its entire width.

Advantageously, a thickness-reduced region is provided in each of the opposite side walls of a C-shaped mounting rail. C-mounting rails form generally a material-intensive profile and, therefore, with a regionwise thickness reduction and the resulting economy of the material, total manufacturing costs of such open elongate profiles can be substantially reduced. In C-shaped mounting rails, the thickness of the bottom section between the openings formed therein and the thickness of side walls can be partially reduced. With provision of shaped profiles in the thickness-reduced regions, the stiffness of such C-shaped mounting rails approximates to stiffness of C-shaped mounting rails without thickness-reduced regions and, thus, with an increased consumption of material.

Advantageously, the shaped profile is formed, as discussed above, transverse to the longitudinal extension of the thickness-reduced region. This insures a satisfactory stiffness of the respective side wall of an open elongate profile.

Preferably, the shaped profile is oriented at an angle to the longitudinal extent of the thickness-reduced profile, whereby inner stresses, which can occur during formation of the shaped profile, can be eliminated in a strip-shaped rolling stock.

Advantageously, the shaped profile is arranged with an offset to at least one side of the side wall in the thickness-reduced region of which the shaped profile is formed. As a result, no section of the shaped profile projects beyond at least one side of the side wall and, thus, does not narrow a receiving space of the open elongate profile which is formed by facing each other, side walls. The shaped profile can project beyond one of the sides of the side wall. The shaped profile can also be formed so that it is offset by the same or different distance with respect to both opposite sides of the side wall. It is contemplated that the shaped profile can project, at least partially, past both opposite sides of the side wall.

Advantageously, the shaped profile is formed by alternatingly arranged recesses and elevations, which can be easily formed and which insure an advantageous stiffening of the thickness-reduced regions of the side walls. Advantageously, both the recesses and the elevations have a cross-sectional trapezoidal shape.

Advantageously, the recesses and the elevation are so formed that with respect to a center plane which extends in the direction of the longitudinal extension of the side surface, the recesses and elevation alternate with each other. This insures a uniform shape of the side wall and eliminates eventual inner stresses in the deformed thickness-reduced region of the side wall.

Advantageously, the recesses and elevations have limiting edges which extend at an angle to their longitudinal extent, whereby eventual inner stresses, which are produced during formation of recesses and elevations, can be eliminated in the thickness-reduced region of the side wall.

The recesses and elevations have, in the plan view, e.g., a parallelogram-shaped or trapezoidal contour, so that adjacent sides of adjacently arranged recesses and elevations advantageously extend parallel to each other.

As discussed above, the method of manufacturing of an open elongate profile having side walls oriented in a direction of a longitudinal extension of the side walls, with at least one side wall having at least one thickness-reduced region, includes forming, with two oppositely arranged profiled rolls, a shaped profile in the at least one thickness-reduced region with the two oppositely arranged profiled rolls in a direction transverse to the longitudinal extension of the at least one side wall. For carrying out the inventive method, two or three deformation steps suffice, so that the profiled rolls can be integrated in a conventional shaping installation in the production process of formation of a strip-shaped rolling stock. Therefore, the additional costs associated with the inventive method form only a very small part of total manufacturing costs. As an initial material for producing an open elongate profile, advantageously, a strip-shaped rolling stock is used which is subsequently deformed in a number of open elongate profiles.

Advantageously, the oppositely arranged profiled rolls have embossing regions with elevated sections and recessed sections engaging in each other for forming the shaped profile in the at least one thickness-reduced region of the at least one side wall. During rolling, the thickness-reduced region, which lies between the embossing regions, is deformed, with the region of the side wall, the thickness of which is not reduced, being fixed with smooth regions of the rolls adjacent to the embossing regions.

Advantageously, the shaped profile is formed in the thickness-reduced region of a side wall extending at an angle to rotational axes of respective profiled rolls. To this end, at least one of the two oppositely arranged profiled rolls has at least one embossing region extending at an angle to the rotational axis of the respective roll. The oppositely located embossing regions of the profiled rolls extend parallel to each other. Because of the inclination of embossing regions relative to the rotational axes of the profiled rolls, the profiled rolls have along these embossing regions different circumferential speeds which cause, during formation of the shaped profile, a so-called longitudinal slip. This longitudinal slip increases the frictional resistance of the profiled roll in a direction transverse to the feeding direction of the side wall. Therefore, during formation of the shaped profile, the side wall is easily stretchable in the thickness-reduced region.

Advantageously, in several side walls, there are formed thickness-reduced regions which extend parallel to each other, and the shaped profiles are formed in the thickness-reduced regions in a single profiling process. The shaped profiles advantageously are formed simultaneously. To this end, the profiled rolls have a number of embossing regions that corresponds to the number of the thickness-reduced regions, e.g. a respective number of embossing regions with elevated sections and with the recessed sections. Between the embossing regions and adjacent thereto, the profiled rolls have small roll surfaces for fixing and eventual rerolling of the side walls.

Advantageously, before the formation of the shaped profile, the free ends of the side wall are deformed, which results in the reduction of stiffniess in these end regions the thickness of which is not reduced. The reduced stiffniess prevents warpage of the free end regions during formation of the shaped profile even when the side wall has a reduced thickness.

The novel features of the present invention, which are considered as characteristic for the invention, are set forth in the appended claims. The invention itself, however, both as to its construction and its mode of operation, together with additional advantages and objects thereof, will be best understood from the following detailed description of the preferred embodiments, when read with reference to the accompanying drawings.

### BRIEF DESCRIPTION OF THE DRAWINGS

The drawings show:

FIG. 1 a cross-sectional view of an open elongate profile according to the present invention;

FIG. 2 a view of a section of the open elongate profile along line II-II in FIG. 1;

FIG. 3 a cross-sectional view along line III-III in FIG. 1;

FIG. 4 a cross-sectional view similar to that of FIG. 3 of another embodiment of an open elongate profile according to the present invention;

FIG. 5 a cross-sectional view similar to that of FIG. 2 of yet another embodiment of an open elongate profile according to the present invention.

FIG. 6 a schematic view of a portion of a device for carrying out the method according to the present invention;

FIG. 7 a cross-sectional view along line VII-VII in FIG. 6; and

FIG. 8 a schematic view of a portion of another embodiment of a device for carrying out the method according to the present invention.

### DETAILED DESCRIPTION OF THE PREFERRED EMBODIMENTS

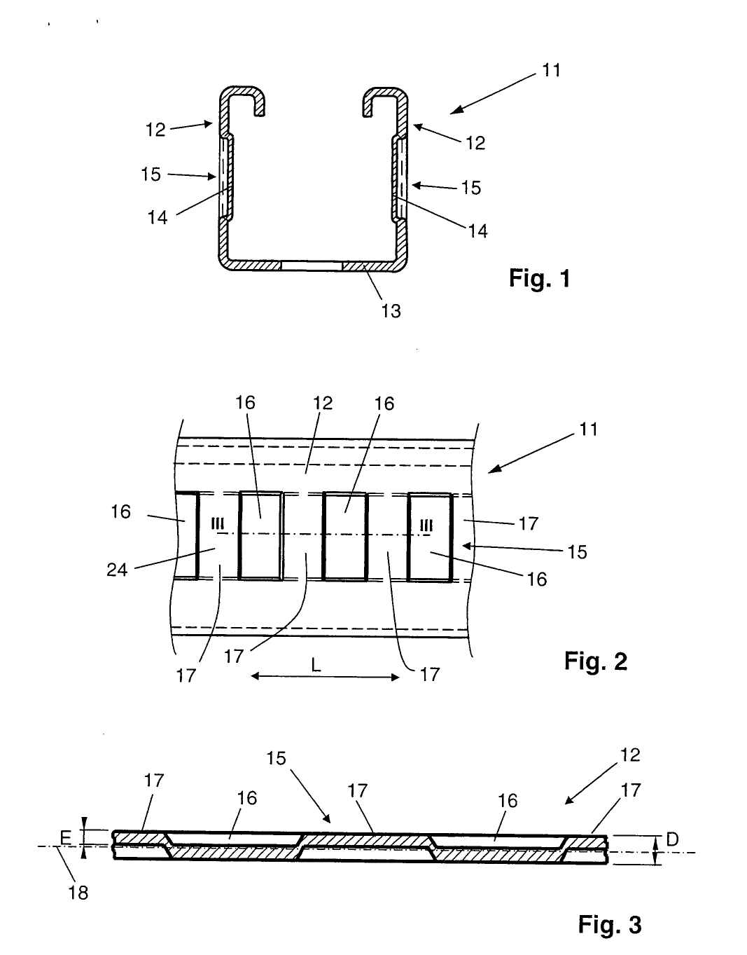

An open elongate profile 11 according to the present invention, a first embodiment of which is shown in FIGS. 1-3, is formed as a C-shaped mounting rail and has two, extending parallel to each other at a distance from each other, side walls 12 and a bottom section 13 connecting the two side walls 12. The side walls 12 have each a thickness-reduced region 14 along a longitudinal extension L of the side walls 12. Each of the thickness-reduced region 14 is provided with a shaped profile 15 extending transverse to the longitudinal extent L of the side wall 12. The shaped profile 15 is formed by alternatively arranged recesses 16 and elevations 17. The recesses 16 and the elevations have a trapezoidal shape (see FIG. 3) and are formed so with respect to a center plane 18 extending in the direction of the longitudinal extent L of the side surfaces 12, that they alternate with each other. In plan view, the recesses 16 and the elevation 17 have a rectangular shape.

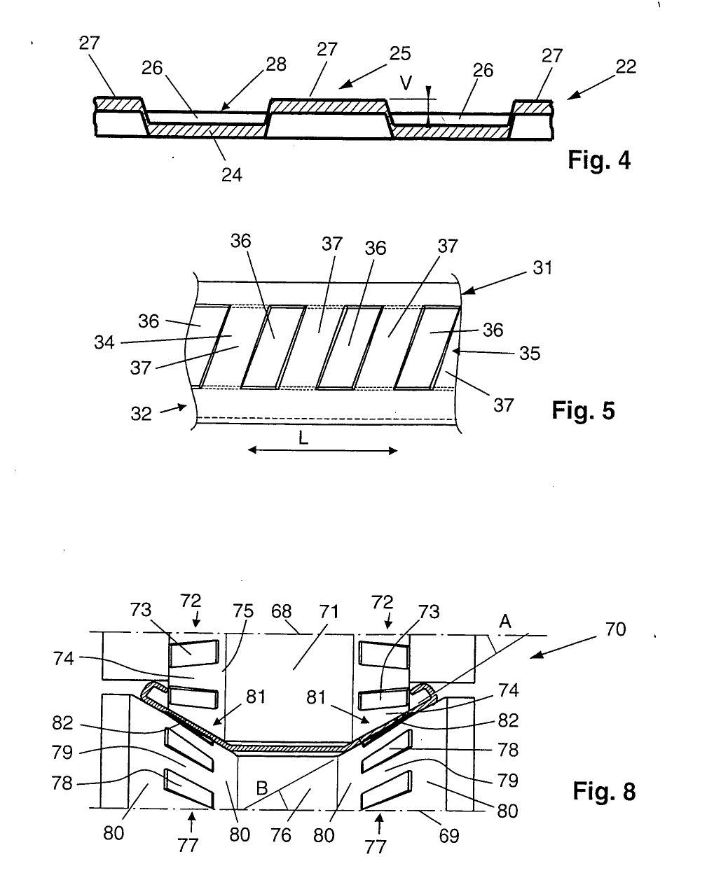

A side wall 22 of another embodiment of an open elongate profile according to the present invention, only a section of which is shown in FIG. 4, has a shaped profile 25 provided in its thickness-reduced region 24 and formed of recesses 26 and elevations 27 which project past a side 28 of the side wall 22 by a distance V.

A side wall 32 of a further embodiment of an open elongate profile according to the present invention, only a section of which is shown in FIG. 5, has a shaped profile 35 in its thickness-reduced region 34 which is likewise formed of recesses 36 and elevations 37 which have, in a plan view, a shape of a parallelogram with limiting edges inclined with respect to the longitudinal extent L of the side wall 32.

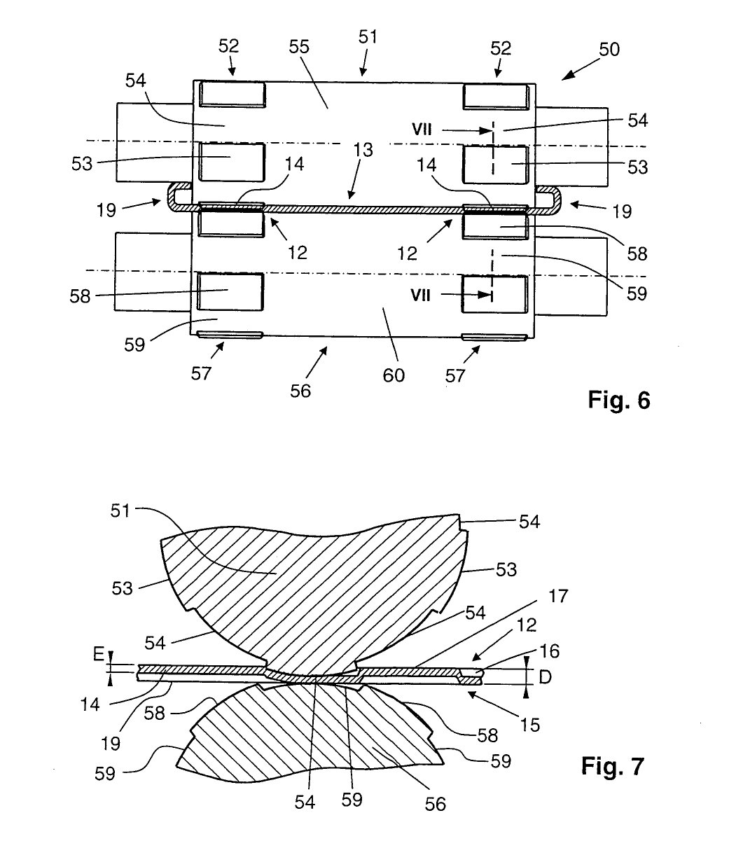

FIGS. 6-7 show a portion 50 of a rolling device for carrying out a method of producing an open elongate profile 11 shown in FIGS. 1-3.

Firstly, in a method step, not shown here, two thickness-reduced regions 14 are formed in a strip-shaped rolling stock in the direction of the longitudinal extension L or in the rolling direction. The thickness-reduced regions 14 have a reduced thickness E that is smaller than the thickness D of the strip-shaped rolling stock in the adjacent region of the strip.

Then, there are formed, in the thickness-reduced region 14 of the side walls 12, with two opposite profiled rolls 51 and 56, recesses 16 and elevations 17 which extend transverse to the longitudinal extent L of the side wall 12 and which form the shaped profile 15.

The profiled rolls 51 and 56 have embossing regions 52, 57, respectively, with elevated sections 53, 58 and recessed sections 54, 59 which engage in each other for forming the shaped profile 15 in the thickness-reduced region 14 of the side wall 12. The profiled roll 51 has, between the embossing regions 52 and adjacent thereto a smooth surface 55, and the profiled roll 57 has, between the embossing regions 58 and adjacent thereto, a smooth surface 60.

Before formation of the shaped profiles 15, the free ends of the side walls 12 are deformed, so that an edge region 11, the thickness D of which is not reduced, has a lower stiffness than an edge region with a non-deformed end. After the shaped profile 15 is formed, the strip-shaped rolling stock is deformed into a C-shaped mounting rail.

FIG. 8 shows a portion 70 of a device for carrying out another method of producing an open elongate profile according to the present invention.

In order to form shaped profiles 85 in a thickness-reduced region 82 of a section of a side wall 81, preliminary, the side wall section is mounted at an angle with respect to rotational axes 78, 79 of oppositely arranged profiled rolls 71, 76, respectively.

The profiled roll 71 has two embossing regions 72 which extend at an angle A with respect to the rotational axis 78 of the profiled roll 71. The profiled roll 76 has two embossing regions 76 which extend at an angle B with respect to the rotational axis 79 of the profiled roll 76. The oppositely arranged embossing regions 72 and 77 extend parallel to each other.

The embossing regions 72 and 77 of the profiled rolls 71, 76 have, respectively, elevated sections 73, 78 and recessed sections 74, 79 which engage in each other to form the shaped profiles 85 in the thickness-reduced regions 82. Between the embossing regions 72 and adjacent thereto, the profiled roll 71 has smooth surfaces 75, and the profiled roll 76 has smooth surfaces 80 between the embossing regions 77 and adjacent thereto.

Though the present invention was shown and described with references to the preferred embodiments, such are merely illustrative of the present invention and are not to be construed as a limitation thereof, and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An open elongate profile, comprising side walls (12, 13; 22; 32) oriented relative to each other in a direction of a longitudinal extent (L) of the side walls, at least one of the side walls (12; 22; 32) having at least one thickness-reduced region (14; 24; 34) along the longitudinal extent (L) thereof; and a shaped profile (15; 25; 35) provided in the at least one thickness-reduced region (14; 24; 34) of the at least one of the side walls (12; 22; 32).

2. An open elongate profile according to claim 1, wherein the open elongate profile forms a C-shaped mounting rail, and the at least one thickness-reduced region (14; 24) is provided on both opposite side walls (12; 22) of the C-shaped mounting rail.

3. An open elongate profile according to claim 1, wherein the shaped profile (15; 25) is oriented transverse to the longitudinal extension (L) of the at least one of the side walls (12; 22).

4. An open elongate profile according to claim 1, wherein the shaped profile (35) is oriented at an angle to the longitudinal extent of the at least one wall (32).

5. An open elongate profile according to claim 1, wherein the shaped profile (25) is arranged with an offset (V) to at least one side (28) of the at least one side wall (22).

6. An open elongate profile according to claim 1, wherein the shaped profile (15; 25) is formed by alternatingly arranged recesses (16; 26) and elevations (17; 27).

7. An open elongate profile according to claim 6, wherein the elevations (37) and the recesses (36) have limiting edges (38, 39) extending at an angle to the extension (L) of the at least one side wall (32).

8. A method of manufacturing an open elongate profile (11; 31; 51) having side walls (12, 13; 22, 32) oriented in a direction of a longitudinal extent of the side walls, with at least one side wall (12; 32; 52) having at least one thickness-reduced region (14; 24; 54), the method comprising the steps providing means having two oppositely arranged profiled rolls (51, 56; 71, 76); and forming a shaped profile (15; 25; 35; 85) in the at least one thickness-reduced region (14; 24; 54; 84) with the two oppositely arranged profiled rolls in a direction transverse to the longitudinal extent (L) of the at least one side wall (12; 32; 52; 82).

9. A method according to claim 8, wherein the step of providing means having two oppositely arranged profiled rolls includes providing profiled rolls (51, 56; 71, 76) having embossing regions (52, 57; 72, 77) having elevated sections (53; 78) and recessed sections (54; 79) engaging in each other for forming the shaped profile (15; 25; 35; 85) in the at least one thickness-reduced region (14; 24; 54; 84) of the at least one side wall (12; 22; 52; 82).

10. A method according to claim 8, wherein the shaped profile (85) is formed in the thickness-reduced region of a side wall (81) extending at an angle to rotational axes (68, 69) of respective profiled rolls (71, 76).
